(19) United States
(12) Patent Application Publication
(10) Pub. No.: US 2021/0086678 A1
(43) Pub. Date: Mar. 25, 2021

(54) Table Arrangement For The Interior Of A Vehicle

(71) Applicant: Audi AG, Ingolstadt (DE)

(72) Inventor: Norbert ENNING, Denkendorf (DE)

(73) Assignee: Audi AG, Ingolstadt (DE)

(21) Appl. No.: 16/970,536

(22) PCT Filed: Jan. 23, 2019
(86) PCT No.: PCT/EP2019/051646

§ 371 Date: Aug. 17, 2020

(30) Foreign Application Priority Data
Mar. 2, 2018 (DE) 10 2018 203 170.3

(51) Int. Cl. B60N 3/00; B60R 11/02

(52) U.S. Cl. CPC B60N 3/001; B60R 2011/0014; B60R 11/0229

(57) ABSTRACT

The present disclosure provides a table arrangement for an interior of a vehicle. The table arrangement includes a table top arrangement having a first table top. The first table top includes an upper side that includes a display and an armrest for a driver of the vehicle. The table arrangement includes a support arm device that pivotably connects the table top arrangement to a bodywork of the vehicle. The table top arrangement includes a second table top congruent to the first table top, and an edge of the first table top is pivotably connected to an edge of the second table top such that the first table top is configured to pivot between a first position and a second position.

### TECHNICAL FIELD

The invention relates to a table arrangement for the interior of a vehicle. The invention further relates to a vehicle having a table arrangement according to the invention.

### BACKGROUND

With increasing semi-autonomous driving or with increasing assisted driving of a vehicle, a driver will more and more often need to carry out only a few or no driving tasks and can therefore devote himself to secondary activities, for which the presence of a table is sometimes necessary. In addition, the reduced driving task will increase communication with the front passenger and rear passengers, such that the need for a table in the driver's area will increase. It is therefore desirable to have a central table in a vehicle as a connecting element for promoting communication and as a common storage area.

A table arrangement is known from DE 10 2006 044 411 A1. This table arrangement for a vehicle cabin of a commercial vehicle comprises a table element which can be pivoted up by means of a lifting scissor system and which is connected to a console via this lifting scissor system. The table element is designed as a storage container which is open at the top and to which a first and a second table top are pivotally articulated on one end and cover the storage container in a cover-like manner when lying congruently one on top of the other. In order to carry out a table function, the first table top lying above is opened in a hinge-like manner into a use position and, together with the second table top, which continues to cover the storage container, forms a common table surface. In order to allow access to the storage container, the second table top is pivoted congruently onto the first table top located in the use position and is set down. Then both table tops can be pivoted back into the position closing the storage container. In this known table arrangement, the table top is formed in two parts, so that the two table tops formed in this way can be opened to form a larger table surface.

In a folding table arrangement according to DE 100 26 561 A1, a cassette is arranged next to a seat cushion of a rear seat, into which a receiving housing for a folding table with a two-part table top can be accommodated. Each of the table top parts is adapted to the width of the receiving housing, the table top parts being connected via hinges. In order to bring the folding table into its functional position, the receiving housing is pivoted upward about a pivot axis located approximately at the height of a front seat edge of the rear seat. The folding table is then pulled up out of the receiving housing and then folded sideways into its functional position, in which it is located in front of the backrest of the rear seat.

DE 10 2015 226 812 A1 describes a rear seat console of a vehicle having an armrest for pivotably closing a console space, in which a folding table is installed, which can be pulled out of the console space when the armrest is open. The position of the folding table can be adapted to the position of a vehicle occupant sitting on the left or right of the rear seat console.

Furthermore, a central armrest for a vehicle seat having a table top function is known from DE 10 2013 015 854 A1. This central armrest has an upper armrest layer and a lower armrest layer, wherein the upper armrest layer is arranged with its underside resting on the upper side of the lower armrest layer and is pivotable relative to the lower armrest layer from a storage position in order to carry out a table top function. The upper armrest layer is formed to be pivotable by means of a pivot device relative to the lower armrest layer by 180° in a use position, such that the underside of the upper armrest layer forms a common planar table top with the upper side of the lower support layer.

Finally, a table arrangement is known from DE 10 2014 002 827 A1, which can be adjusted from a stowed position in a central console of a vehicle into a use position, wherein this central console is closable by a central armrest which is pivotably hinged to the same.

### SUMMARY OF INVENTION

Based on this prior art, it is an object of the invention to provide a table arrangement for the interior of a vehicle having an expanded range of functions.

Such a table arrangement for the interior of a vehicle comprises the following components:
a table top arrangement having at least a first table top, wherein the upper side thereof is formed with a display and has an armrest for a driver of the vehicle, and
a support arm device with which the table top arrangement is pivotally connected to a bodywork of the vehicle.

The table top arrangement of such a table arrangement serves not only as the storage area of objects, but also as an armrest for the driver of the vehicle and is also used as a display. Such a display can be used as a desktop surface, for displaying a cell phone screen or for displaying vehicle-specific information in a freely configurable manner. Finally, the pivotability of the table top arrangement ensures a position of the first table top of the table top arrangement that is adapted to be used by a vehicle occupant. Particularly when using the display, the first table top can be pivoted into a suitable position.

The use of the table top arrangement as an armrest for the driver naturally presupposes that the table arrangement is pivotally connected to the vehicle bodywork adjacent to the driver's seat, such as, for example, in the area of the central console of the vehicle.

The disclosed embodiments of the invention provide an advantageous development.

For example, the table top arrangement has a second table top which is congruent to the first table top, and

For example, the first and second table tops are pivotally connected at the edge with a hinge in such a way that the first table top is pivotable between a first position in which it is arranged congruently on the second table top, and a second position, in which the first table top together with the second table top form a flat table surface.

With such a second table top, the table surface of the first table top can be doubled.

According to a further embodiment of the invention, not only the upper side of the first table top is designed having a display, but also the underside thereof is designed having a display. In addition, the upper side of the second table top also has a display, so that when the second table top is in the open state, a large display is created together with the first table top. Such a table surface consisting of the two table tops having a display surface can be used as a PC or tablet screen, for playing PC games, such as board games, or for meetings documents that can be freely positioned, moved, or rotated in different windows.

According to a further embodiment of the invention, it is particularly advantageous even if the second table top is designed having a display on the underside. The table created with the second table top opened can thus be pivoted into a vertical position, such that the underside thereof can be used as a television or screen.

According to a further embodiment of the invention, it is provided that:
the support arm device comprises a support arm which is pivotally connected at one end by means of a first pivot joint to the bodywork of the vehicle, and
the table top arrangement is pivotally connected to another end of the support arm by means of a second pivot joint.

The second table top is preferably pivotally connected to the support arm by means of the second pivot joint.

The table top arrangement of the table arrangement according to an embodiment of the invention can thus be pivoted in a horizontal position into a plurality of vehicle directions.

To set up a basic position of the table arrangement, an example embodiment can include:
a first wedge-shaped stop is provided at the end of the support arm connected to the bodywork, which is designed to support the support arm in a direction inclined relative to the body floor, and
a second stop is arranged on the support arm, which is designed to support the table top arrangement in a horizontal position.

This basic position of the table arrangement is set up in such a way that a driver can comfortably place his arm on the armrest arranged on the upper side of the first table top. From this basic position, the table top arrangement can be pivoted into a wide variety of positions depending on the use.

According to a further advantageous embodiment of the invention, the first pivot joint and/or the second pivot joint is configured as a latching joint. Depending on the latching of such a latching joint, the table top arrangement and the support arm can be manually adjusted in different positions and latched there.

In one particular embodiment of the invention, the first pivot joint and/or the second pivot joint can be adjusted by means of a self-locking motor-driven pivot drive. This opens up the possibility that the table arrangement can be automatically adjusted to predetermined positions from the basic position by means of the pivot drives of the two pivot joints, with the proviso that the table top arrangement is always aligned in a horizontal direction with respect to the body floor. It is advisable to design such pivot drives as electrical drives.

Furthermore, it is provided according to an embodiment that the pivot axes of the two pivot joints are aligned in the transverse direction of the vehicle. This makes it possible for the table top arrangement to be pivoted in a horizontal position in the vertical direction of the vehicle or in the longitudinal direction of the vehicle.

Finally, according to a further advantageous embodiment of the invention, the table arrangement is designed such that the table top arrangement can be displaced in the transverse direction of the vehicle relative to the support arm device. This makes is possible for the driver, for example, in the self-driving operation of the vehicle when the driver's seat is moved backwards, to move the table top arrangement to the driver's side in order to be able to use it comfortably.

The table arrangement according to an embodiment of the invention is suitable for use for all vehicle types and their models, in particular also in people carriers, in which, for example, a passenger seat can be rotated in the rearward direction in order to allow the table arrangement to be used by a front passenger and rear passengers.

### BRIEF DESCRIPTION OF THE FIGURES

Further advantages, features and details of the invention will become apparent from the claims, the following description of preferred embodiments and from the drawings. In the drawings:

FIG. 1 is a schematic side view of a table arrangement according to an embodiment of the invention installed in the area of a front seat of a vehicle in a basic position,

FIG. 2 is a perspective representation of the front interior of the vehicle with a table arrangement according to FIG. 1,

FIG. 3 is a schematic side view of the table arrangement according to FIG. 1 in a use position pivoted out of the basic position,

FIG. 4 is a perspective representation of the interior of the vehicle with a table arrangement according to FIG. 3, and

FIG. 5 is a perspective representation of the interior of the vehicle with a table arrangement according to FIG. 1 in a position used as a television or cinema screen.

### DETAILED DESCRIPTION OF THE FIGURE

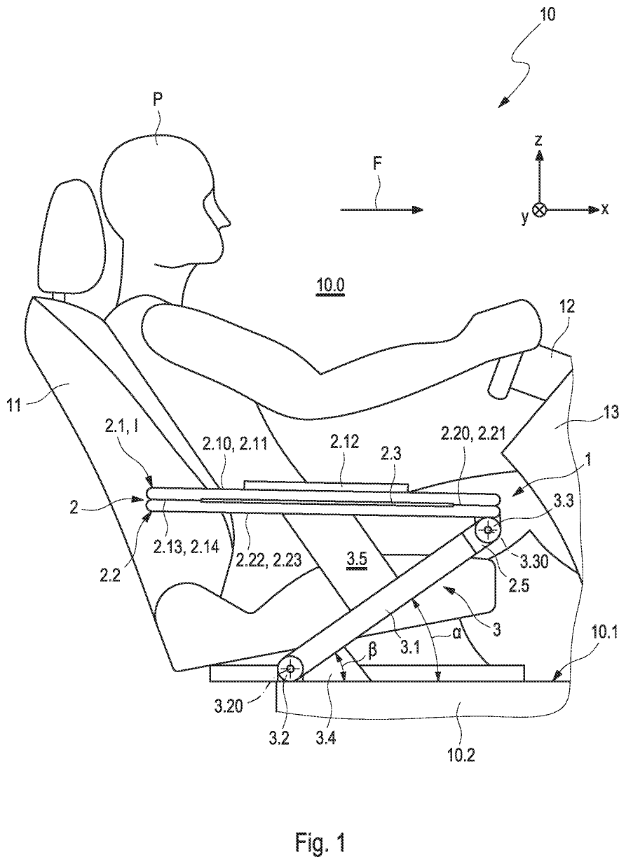

FIGS. 1 to 5 show a table arrangement 1 which is installed in a vehicle-fixed manner in a vehicle interior 10.0 of a vehicle 10 and which is shown as a multifunctional table in various use positions.

This table arrangement 1 also comprises a table top arrangement 2 having two superimposed, identically contoured table tops, namely a first table top 2.1 and a second table top 2.2, and a support arm device 3 with which the table top arrangement 2 is pivotally connected to a body floor 10.2 of a vehicle body 10.1 of the vehicle 10.

The support arm device 3 comprises a support arm 3.1, which is pivotally connected at the lower end with respect to the vertical direction of the vehicle (z direction) by means of a first pivot joint 3.2 to the body floor 10.2 of the vehicle body 10.1, wherein the pivot axis 3.20 of this first pivot joint 3.2 extends in the transverse direction of the vehicle (y direction).

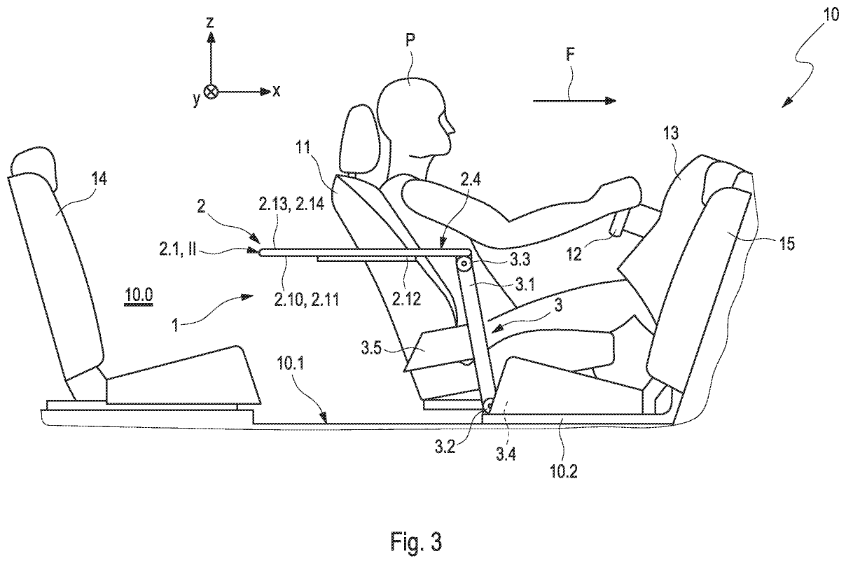

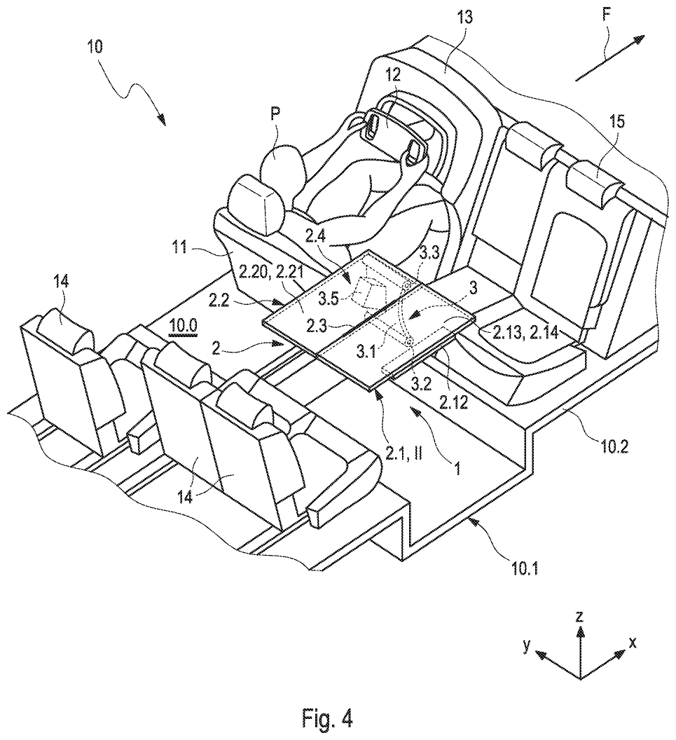

At the upper end of the support arm 3.1 seen in the vertical direction of the vehicle (z direction), a second pivot joint 3.3 connects the support arm 3.1 to the table top arrangement 2, namely to the second table top 2.2, via a pivot axis 3.30 likewise extending in the transverse direction of the vehicle (y direction) wherein the first table top 2.1 is congruently arranged on said second table top in a first position I. The table top lying above, that is the first table top 2.1, is connected to the second table top 2.2 via a hinge 2.3, such that the first table top 2.1 is pivotable by 180° from the position I to the position II by means of the hinge 2.3 in the plane of the second table top 2.2 to form a common flat table surface together with the second table top 2.2, as shown in FIGS. 3 and 4.

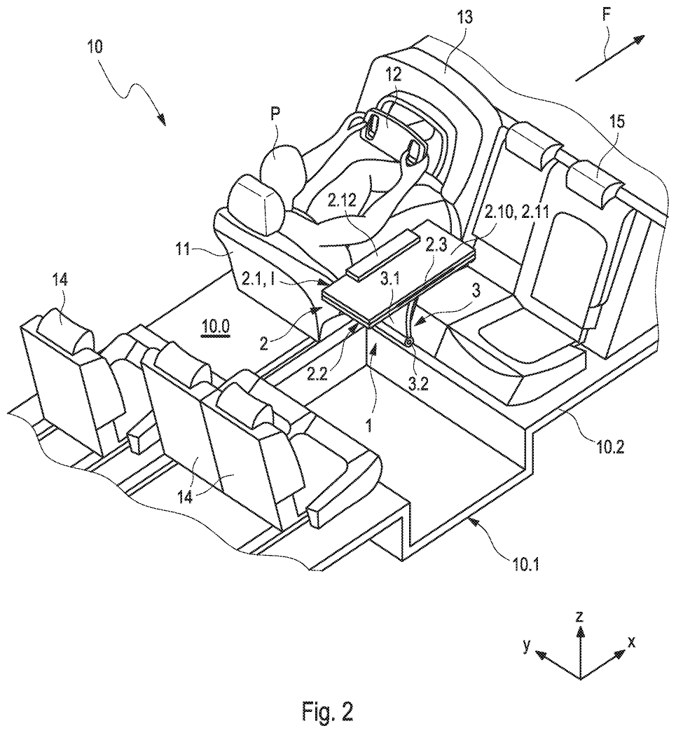

With these two pivot joints 3.2 and 3.3, on the one hand the support arm 3.1 can be pivoted relative to the body floor 10.2 and on the other hand the table top arrangement 2 can be pivoted relative to the support arm 3.1. In order to achieve a stable basic position of the table arrangement 1 according to FIGS. 1 and 2, a first stop 3.4 and a second stop 3.5 are provided.

The first stop 3.4 has a wedge-shaped contour and, viewed in the direction of travel F of the vehicle 10, is arranged in front of the first pivot joint 3.2 at the lower end of the support arm 3.1 between the body floor 10.2 and the support arm 3.1 such that the support arm 3.1 is supported in an inclined position in the direction F of the vehicle. The angle of inclination a of the support arm 3.1 is determined by the wedge angle of the first stop 3.4.

The second stop 3.5 is flange-shaped and is integrally formed on the central area of the support arm 3.1, projecting vertically. The free end of this second stop 3.5 lies on the underside 2.22 of the second table top 2.2, as a result of which the table top arrangement 2 is supported and its position is stabilized. The length of this second stop 3.5 is selected such that the table top arrangement 2 is supported in a horizontal position, i.e. parallel to the body floor 10.2, at the angle of inclination a of the support arm 3.1.

The mounting point of the first pivot joint 3.2 is located on the body floor 10.2 in relation to the longitudinal direction of the vehicle (x direction) adjacent to a driver seat 11 in the area of a central console of the vehicle 10, such that a driver P can comfortably place his right arm on an armrest 2.12 arranged on the upper side 2.10 of the first table top 2.1, wherein the first table top 2.1 is in the first position I thereof, where the first table top 2.1 is lying on the second table top 2.2.

In particular, FIG. 2 shows the geometric shape of the contour of the two table tops 2.1 and 2.2, each of which has an identical rectangular shape, wherein the longitudinal sides extend in the longitudinal direction of the vehicle (x direction).

The armrest 2.12 has a rectangular contour, wherein the longitudinal sides extend in the longitudinal direction of the vehicle (x-calculation) and are shorter than the length of the long sides of the first tabletop 2.1, wherein the width of the armrest 2.12 in the transverse direction of the vehicle is also small in comparison to the width of the first table top 2.1. The armrest 2.12 is centrally arranged in relation to the longitudinal side of the first table top adjacent to the driver's seat 11 on top of said first table top, such that the longitudinal side of the armrest 2.12 adjacent to the driver's seat is flush with the longitudinal side of the first table top adjacent to the driver's seat. The armrest 2.12 can be designed with a padded surface layer so that the driver can rest his arm comfortably thereon.

The hinge 2.3 is arranged on the longitudinal edges of the two table tops 2.1 and 2.2 opposite to the driver's seat 11 and running in the longitudinal direction of the vehicle (x-direction), such that the first table top 2.1 can be opened from the position I according to FIG. 2 against the direction of the driver's seat 11 into the position II according to FIG. 3 or FIG. 4. This creates a table surface 2.4 formed by the two table tops 2.1 and 2.2, in which the armrest 2.12 comes to rest on the underside of this table surface 2.4, as can be seen in particular from FIG. 3.

The upper side 2.10 of the first table top 2.1 is formed with a display 2.11, wherein the entire upper side 2.10 outside the armrest 2.12 can be designed as a display 2.11 or only a partial area of the upper side 2.10. This display 2.11 can be designed at least in some areas having a touchscreen in order to be able to carry out vehicle and/or entertainment functionalities by the driver or a front passenger.

Furthermore, the underside 2.13 of the first table top 2.1 is also designed with a display 2.14 and, likewise, the upper side 2.20 of the second table top 2.2 is also designed with a display 2.21. This creates a table surface according to FIG. 4 when the first table top 2.1 is in the open state, the entire surface of which can be used as a display, either as a PC or tablet screen, for playing PC games, such as board games, or for meetings documents which can be freely positioned, moved, or rotated in different windows.

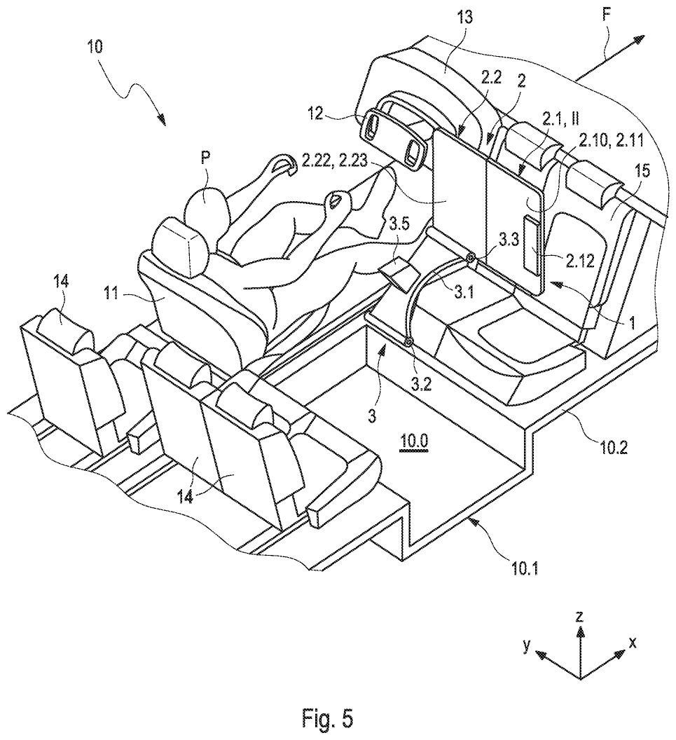

Finally, if the underside of the second table top 2.2 is designed having a display 2.23, when the table top arrangement 2 is in the open state, the surface that is created from the upper side 2.10 of the first table top 2.1 and the underside of the second table top 2.2 can be used as a television or cinema screen for rear passengers of the vehicle 10 when the table top arrangement 2 is pivoted into an approximately vertical position when the first table top 2.1 is opened, as shown in FIG. 5.

From the basic position according to FIGS. 1 and 2, the table arrangement 1 can be pivoted into different use positions, as is shown, for example, in FIGS. 3 and 4 with the first table top 2.1 opened. From the basic position according to FIG. 1, the support arm 3.1 can only be pivoted against the direction of travel F and the table top arrangement 2 can only be pivoted in the direction opposite to the second stop 3.4. Thus, the table top arrangement 2 together with the support arm 3.1 can be pivoted from the basic position according to FIG. 1 against the direction of travel F of the vehicle while maintaining the horizontal position of the table top arrangement 2, wherein the height of the table top arrangement 2 changes slightly relative to the body floor 10.2 when pivoting the support arm 3.1. Here, the table top arrangement 2 shifts in the direction of the rear seats 14, that is, counter to the direction of travel F of the vehicle 10.

In order to secure a stable position in such use position in the table arrangement 1, the two pivot joints 3.2 and 3.3 are configured as latching joints.

Alternatively, the two pivot joints 3.2 and 3.3 can be adjusted by means of a self-locking motor-driven pivot drive, wherein these pivot drives include an electrical drive and a self-locking or self-blocking gear. Using a suitable control unit, a plurality of defined positions including the basic position of the table arrangement 1 can be programmed, such that these different positions can be selected and adjusted using a suitable operating element. These different positions are programmed in such a way that the table top arrangement 2 is always aligned horizontally to the body floor 10.2 at these positions.

Furthermore, it is also possible that the hinge function realized by means of the hinge 2.3 is also automated by means of an electrical drive.

The interior 10.0 of the vehicle 10 has, in addition to the driver seat 11, two front passenger seats 15 which are oriented counter to the direction of travel F, such that passengers in the passenger seats 15 and the rear seats 14 face each other.

In the basic position of the table arrangement 1 according to FIG. 2, in addition to the driver P, the passengers in the front passenger seat 15 can thus use the table top arrangement 2 both in its non-opened state and in its opened state.

The table arrangement 1 pivoted from the basic position according to FIG. 1 into a use position according to FIGS. 3 and 4 can be used jointly by both the rear passengers and the passengers of the front passenger seat 15, in particular if the table top arrangement 2 is opened, as can be seen from FIG. 4.

In the use position in FIG. 4, the surface of the unfolded table top arrangement 2 can be used as a display both by the passengers in the front passenger seats 15 and by the rear passengers in the rear seats 14. This display is composed of the display 2.14 on the underside 2.13 of the first table top 2.1 and the display 2.21 on the upper side 2.20 of the second table top 2.2.

If this unfolded table top arrangement 2 according to FIG. 4 is pivoted from the basic position according to FIG. 1 into a vertical direction corresponding to FIG. 5, the rear side of the unfolded table top arrangement 2 is used by the rear passengers in the rear seats 14 as a television and/or cinema screen, as is already the case as explained above. It can also be used as an avatar for the driver, for example as screen telephony. Of course, the front passenger seats cannot be occupied with this use.

When the table arrangement 1 is positioned for use as a screen, when the table top arrangement 2 is set up vertically, different contents can be displayed to front passengers in the front passenger seats 15 and rear passengers in the rear seats 14, for example also for interactive use as touchscreens.

If the driver is released from his driving tasks in a self-driving vehicle 10, in such situations the driver can adjust his driver's seat 11 against the direction of travel F in accordance with the representation according to FIG. 5, to use the display on the back of the unfolded table top arrangement 2 as a television and/or cinema screen at a sufficient distance from a steering wheel 12 and a dashboard 13 of the vehicle 10. Such use by the driver can be made more comfortable if the table top arrangement 2 together with the second pivot joint 3.3 can be displaced relative to the support arm 3.1 in the direction of the driver, that is to say in the transverse direction of the vehicle (y direction). This can be achieved with a sliding rail 2.5, which is only indicated schematically in FIG. 1.

### REFERENCE SIGNS

1 table arrangement
2 table top arrangement of the table arrangement 1
2.1 first table top of the table top arrangement 2
2.10 upper side of the first table top 2.1
2.11 display on the upper side 2.10
2.12 armrest on the upper side 2.10
2.13 underside of the first table top 2.1
2.14 display on the underside 2.13
2.2 second table top of the table top arrangement 2
2.20 upper side of the second table top 2.2
2.21 display on the upper side 2.20
2.22 underside of the second table top 2.2
2.23 display on the underside 2.22
2.3 hinge of the table top arrangement 2
2.4 table surface
2.5 sliding rail
3 support arm device
3.1 support arm of the support arm device 3
3.2 first pivot joint of the support arm device 3
3.20 pivot axis of the first pivot joint 3.2
3.3 second pivot joint of the support arm device 3
3.30 pivot axis of the second pivot joint 3.3
3.4 first stop of the support arm device 3
3.5 second stop of the support arm device 3
10 vehicle
10.0 interior of the vehicle 10
10.1 bodywork of the vehicle 10
10.2 body floor of the bodywork 10.1
11 driver's seat of vehicle 10
12 steering wheel of the vehicle 10
13 dashboard of the vehicle 10
14 rear seats of the vehicle 10
15 front passenger seats
I first position of the first table top 2.1
II second position of the first table top 2.1
F direction of travel of the vehicle 10
P driver of vehicle 10

1-12. (canceled)

13. A table arrangement for an interior of a vehicle, comprising:
a table top arrangement including a first table top, wherein the first table top includes an upper side comprising a display and an armrest for a driver of the vehicle; and
a support arm device pivotably connecting the table top arrangement to a bodywork of the vehicle.

14. The table arrangement according to claim 13, wherein the table top arrangement includes a second table top congruent to the first table top,
wherein an edge of the first table top is pivotably connected to an edge of the second table top such that the first table top is configured to pivot between a first position and a second position, and
wherein when set at the first position, the first table top is superimposed with respect to the second table top, and wherein when set at the second position, the first table top is juxtaposed with respect to the second table top to form a flat table surface.

15. The table arrangement according to claim 14, wherein an underside of the first table top and an upper side of the second table top each comprise a display.

16. The table arrangement according to claim 14, wherein an underside of the second table top comprises a display.

17. The table arrangement according to claim 14, wherein the support arm device comprises a support arm having a first end pivotally connected to the bodywork of the vehicle by a first pivot joint, and
wherein the support arm has a second end pivotably connected to the table top arrangement by a second pivot joint.

18. The table arrangement according to claim 17, wherein the second table top is pivotably connected to the support arm by the second pivot joint.

19. The table arrangement according to claim 17, wherein the support arm device includes
a first wedge-shaped stop disposed at the first end of the support arm connected to the bodywork, the first wedge-shaped stop configured to support the support arm in an inclined direction relative to the body floor, and
a second stop disposed on the support arm, the second stop configured to support the table top arrangement when set in a horizontal position.

20. The table arrangement according to claim 17, wherein the first pivot joint and the second pivot joint comprise a latching joint.

21. The table arrangement according to claim 17, wherein the first pivot joint and the second pivot joint are configured to be adjusted by a self-locking motor-driven pivot drive.

22. The table arrangement according to claim 17, wherein the first pivot joint defines a first pivot axis and the second pivot joint defines a second pivot axis, and the first and second pivot axes are each aligned in a direction extending transverse to the vehicle.

23. The table arrangement according to claim 13, wherein the table top arrangement is configured to be displaced from the support arm device in a direction extending transverse to the vehicle.

24. A vehicle comprising:
a body work; and
a table arrangement, wherein the table arrangement comprises:
a table top arrangement including a first table top, wherein the first table top includes an upper side comprising a display and an armrest for a driver of the vehicle, and
a support arm device pivotably connecting the table top arrangement to the bodywork.
